(19) United States
(12) Patent Application Publication
(10) Pub. No.: US 2026/0121779 A1
(43) Pub. Date: Apr. 30, 2026

(54) PROACTIVE TIME SYNCHRONIZATION

(71) Applicant: Dell Products L.P., Round Rock, TX (US)

(72) Inventors: Parminder Singh SETHI, Punjab (IN); Pandiyarajan MANI, Gudiyattam (IN); Akbar SHERIFF, Salem (IN)

(73) Assignee: Dell Products L.P., Round Rock, TX (US)

(21) Appl. No.: 18/925,956

(22) Filed: Oct. 24, 2024

(51) Int. Cl. H04J 3/06

(52) U.S. Cl. CPC H04J 3/0685

(57) ABSTRACT

An information handling system may include at least one processor, a memory, and a plurality of information handling resources each configured to execute a client configured to perform clock synchronization over a network. The information handling system may be configured to: poll the plurality of information handling resources to determine a time configuration associated with the clients executing on the respective information handling resources; determine a common time configuration based at least in part on a geographic location of the information handling system; and propagate the common time configuration to the clients executing on the respective information handling resources.

### TECHNICAL FIELD

The present disclosure relates in general to information handling systems, and more particularly to techniques for synchronizing the system time across multiple devices.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems may generally include multiple information handling resources that use Network Time Protocol (NTP) or other network-based techniques for their time configuration. For example, components such as a host operating system (OS), a baseboard management controller (BMC), a management service module (MSM), an embedded controller (EC), a virtualization manager (e.g., vCenter), a management I/O module (IOM), and others may all include an implementation of an NTP client.

It is possible for different components to have different NTP configurations, however, leading to time mismatches that can cause various issues. For example, components could have different time zone settings. In other cases, a misconfiguration could prevent one component from accessing NTP at all, etc.

In some cases, internal chassis communications may break down due to the time mismatch. Security loopholes may also be opened, allowing cyber-attacks. Problems may also affect logging and event monitoring systems, because different components having different local time setups can make it difficult to correlate logs.

Embodiments of this disclosure address these issues by providing for proactive time synchronization across devices. It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with time synchronization may be reduced or eliminated.

In accordance with embodiments of the present disclosure, an information handling system may include at least one processor, a memory, and a plurality of information handling resources each configured to execute a client configured to perform clock synchronization over a network. The information handling system may be configured to: poll the plurality of information handling resources to determine a time configuration associated with the clients executing on the respective information handling resources; determine a common time configuration based at least in part on a geographic location of the information handling system; and propagate the common time configuration to the clients executing on the respective information handling resources.

In accordance with these and other embodiments of the present disclosure, a method may include an information handling system executing, on each of a plurality of information handling resources, a client configured to perform clock synchronization over a network; the information handling system polling the plurality of information handling resources to determine a time configuration associated with the clients executing on the respective information handling resources; the information handling system determining a common time configuration based at least in part on a geographic location of the information handling system; and the information handling system propagating the common time configuration to the clients executing on the respective information handling resources.

In accordance with these and other embodiments of the present disclosure, an article of manufacture may include a non-transitory, computer-readable medium having computer-executable instructions thereon that are executable by an information handling system for: executing, on each of a plurality of information handling resources, a client configured to perform clock synchronization over a network; polling the plurality of information handling resources to determine a time configuration associated with the clients executing on the respective information handling resources; determining a common time configuration based at least in part on a geographic location of the information handling system; and propagating the common time configuration to the clients executing on the respective information handling resources.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates an example method, in accordance with embodiments of the present disclosure.

### DETAILED DESCRIPTION

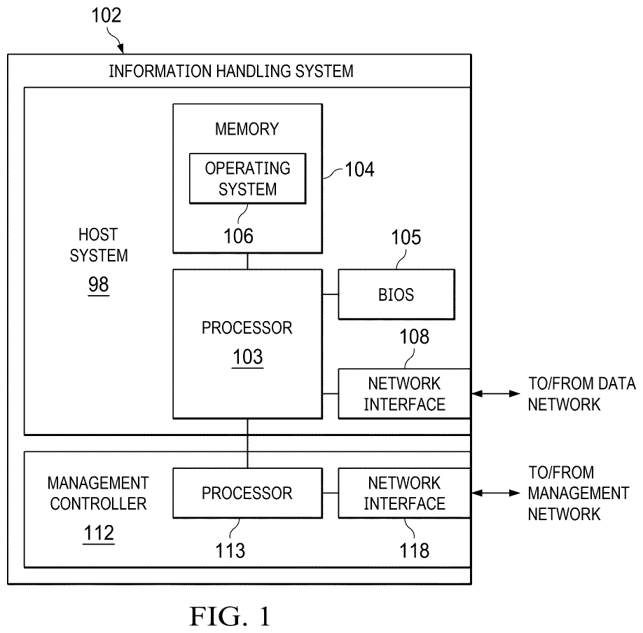

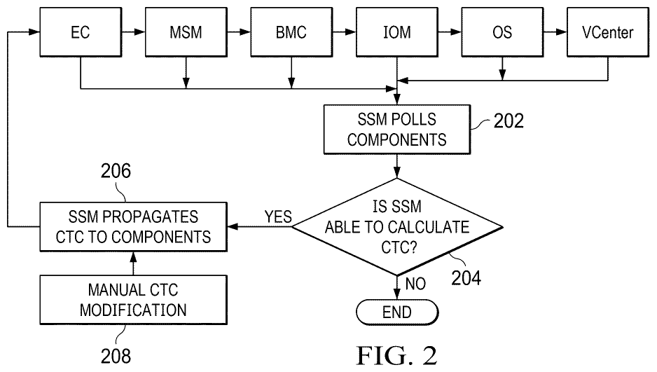

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide techniques for synchronizing the time settings of multiple devices (e.g., multiple components of a single information handling system). Embodiments may implement time sync polling on a periodic basis (e.g., every 30 minutes) across various devices and components that rely on internal chassis communication protocols like I2C, Redfish, DFS, and Racadm. When the system detects a lack of synchronization between devices, it may notify a user about the error.

Additionally, because a lack of time synchronization may impact intra-chassis communications, the system may act to restore connectivity by issuing a new communication token. For example, an automated process may restart the service (e.g., avahi) that performs network discovery and configuration in order to cause it to re-issue a new communication token. An internal re-inventory may then take place to allow the chassis components to begin communicating using the new token.

Embodiments may implement a Synergy Sync Module (SSM), which may execute on a management controller such as a BMC to synchronize all chassis components and propagate identical NTP configurations to them. The SSM may analyze various chassis components, aiming to identify a Common Time Configuration (CTC) that serves as the optimal NTP setting for all chassis components.

The SSM may implement geographical location analysis to determine the geographical location of the chassis infrastructure and derive the appropriate CTC accordingly. It may also implement automatic configuration synchronization across all chassis components, while still allowing users the flexibility to modify configurations manually if needed.

For example, suppose the SSM calculates a CTC for a chassis based on its geographic location and propagates the CTC to all components. This ensures that the NTP configuration across all chassis components is aligned. If a user modifies the CTC manually, the updated configuration may then also propagate to all components automatically.

The SSM may also periodically perform time sync polling to ensure that the chassis components have remained in sync (e.g., synchronized in terms of both their NTP configurations and in terms of their views of what the current system time is). If the SSM detects a lack of synchronization (or is unable to contact some component), it may send a notification to a user in the form of a system event error log. This alert may trigger the system to reissue the communication token to the chassis components (e.g., by restarting the avahi service on the BMC). Once the new token is generated, the BMC may perform a re-inventory, including NTP re-configuration, and sync all chassis components with the CTC.

FIG. 2 shows a flowchart of an example method. At step 202, the SSM executing on the BMC may poll all chassis components (including the BMC itself).

At step 204, the SSM attempts to calculate a CTC that is suitable for deployment across all chassis components. If this process fails for some reason, the method may end. If it succeeds, then the CTC may be propagated to all components at step 206 and the method may loop to continue polling components for NTP issues.

At step 208, if a user enters a manual adjustment to the CTC, this may also be incorporated and propagated to the chassis components during the next polling cycle.

One of ordinary skill in the art with the benefit of this disclosure will understand that the preferred initialization point for the method depicted in FIG. 2 and the order of the steps comprising that method may depend on the implementation chosen. In these and other embodiments, the method may be implemented as hardware, firmware, software, applications, functions, libraries, or other instructions. Further, although FIG. 2 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the method.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S. C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor;
a memory; and
a plurality of information handling resources each configured to execute a client configured to perform clock synchronization over a network;
wherein the information handling system is configured to:
poll the plurality of information handling resources to determine a time configuration associated with the clients executing on the respective information handling resources;
determine a common time configuration based at least in part on a geographic location of the information handling system; and
propagate the common time configuration to the clients executing on the respective information handling resources.

2. The information handling system of claim 1, wherein the clients are network time protocol (NTP) clients.

3. The information handling system of claim 1, wherein the polling is performed by a baseboard management controller (BMC) of the information handling system.

4. The information handling system of claim 1, wherein the polling is performed repeatedly at periodic intervals.

5. The information handling system of claim 1, wherein the common time configuration is updatable by a user of the information handling system.

6. The information handling system of claim 1, wherein the information handling resources are disposed within a single chassis.

7. A method comprising:
an information handling system executing, on each of a plurality of information handling resources, a client configured to perform clock synchronization over a network;
the information handling system polling the plurality of information handling resources to determine a time configuration associated with the clients executing on the respective information handling resources;
the information handling system determining a common time configuration based at least in part on a geographic location of the information handling system; and
the information handling system propagating the common time configuration to the clients executing on the respective information handling resources.

8. The method of claim 7, wherein the clients are network time protocol (NTP) clients.

9. The method of claim 7, wherein the polling is performed by a baseboard management controller (BMC) of the information handling system.

10. The method of claim 7, wherein the polling is performed repeatedly at periodic intervals.

11. The method of claim 7, wherein the common time configuration is updatable by a user of the information handling system.

12. The method of claim 7, wherein the information handling resources are disposed within a single chassis.

13. An article of manufacture comprising a non-transitory, computer-readable medium having computer-executable instructions thereon that are executable by an information handling system for:
executing, on each of a plurality of information handling resources, a client configured to perform clock synchronization over a network;
polling the plurality of information handling resources to determine a time configuration associated with the clients executing on the respective information handling resources;
determining a common time configuration based at least in part on a geographic location of the information handling system; and
propagating the common time configuration to the clients executing on the respective information handling resources.

14. The article of manufacture of claim 13, wherein the clients are network time protocol (NTP) clients.

15. The article of manufacture of claim 13, wherein the polling is performed by a baseboard management controller (BMC) of the information handling system.

16. The article of manufacture of claim 13, wherein the polling is performed repeatedly at periodic intervals.

17. The article of manufacture of claim 13, wherein the common time configuration is updatable by a user of the information handling system.

18. The article of manufacture of claim 13, wherein the information handling resources are disposed within a single chassis.
